(19) United States
(12) Patent Application Publication
(10) Pub. No.: US 2026/0131646 A1
(43) Pub. Date: May 14, 2026

(54) VEHICLE SPARE WHEEL AND TIRE ASSEMBLY WITH BATTERY

(71) Applicant: Ford Global Technologies, LLC, Dearborn, MI (US)

(72) Inventors: Keith Weston, Canton, MI (US); John Robert Van Wiemeersch, Novi, MI (US); Stuart C. Salter, White Lake, MI (US); Todd Ansbacher, Westland, MI (US); David Celinske, Wolverine Lake, MI (US); Frank Lollo, Plymouth, MI (US)

(73) Assignee: Ford Global Technologies, LLC, Dearborn, MI (US)

(21) Appl. No.: 18/943,649

(22) Filed: Nov. 11, 2024

(51) Int. Cl. B60K 1/04; B62D 43/02

(52) U.S. Cl. CPC B60K 1/04; B62D 43/02; B60K 2001/0416; B60K 2001/045

(57) ABSTRACT

A vehicle including a spare wheel and tire assembly is disclosed. The wheel and tire assembly may include a tire and a wheel. The vehicle may further include a battery cell mounted in the wheel and tire assembly. The battery cell may store and provide power. In some aspects, the battery cell may be removably mounted in the spare wheel and tire assembly. In other aspects, the battery cell may be integrated with the spare wheel and tire assembly.

### TECHNICAL FIELD

The present disclosure relates to vehicles, and more particularly, to a vehicle's wheel and tire assembly.

### BACKGROUND

With the increasing number of electric vehicles (EVs), the EV landscape is rapidly evolving. An EV operates on electric energy, and a vehicle user is required to charge the vehicle battery regularly to ensure uninterrupted vehicle operation.

In general, overlanding adventure involves unanticipated excess energy consumption which can lead to reduced range of an EV and may create range anxiety in the vehicle user. The fear of potentially being stranded in a vehicle without power and without access to a charging facility may cause range anxiety. In some scenarios, the vehicle users may require additional power/energy in the vehicle to finish the job/adventure.

Further, the overlanding adventure may require one or more spare wheel and tire assemblies. The spare wheel and tire assembly is generally positioned in the vehicle (e.g., in or under a truck bed or on a liftgate).

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example vehicle in accordance with the present disclosure.

FIG. 2 depicts front and cross-sectional views of a spare wheel and tire assembly and a battery pack, in accordance with the present disclosure.

FIG. 3 depicts front and cross-sectional views of assembled spare wheel and tire assembly and a battery pack, in accordance with the present disclosure.

FIG. 4 depicts a view of an exemplary first connection mechanism to connect a battery pack with a wheel, in accordance with the present disclosure.

FIG. 5 depicts a view of an exemplary second connection mechanism to connect a battery pack with a wheel, in accordance with the present disclosure.

FIG. 6 depicts a view of an exemplary third connection mechanism to connect a battery pack with a wheel, in accordance with the present disclosure.

FIG. 7 depicts front and cross-sectional views of a spare wheel and tire assembly with integrated battery cells, in accordance with the present disclosure.

### DETAILED DESCRIPTION

### Overview

The present disclosure describes a spare wheel and tire assembly of a vehicle having one or more battery cells mounted in the spare wheel and tire assembly. The spare wheel and tire assembly may include a wheel and a tire. In some aspects, the battery cells may be removably mounted in the spare wheel and tire assembly. For instance, the battery cells may be removably mounted in the wheel. Alternatively, the battery cells may be integrated in the spare wheel and tire assembly. For instance, the battery cells may be removably integrated with the tire.

In aspects, the battery cells may be assembled in a battery pack, which may be removably mounted in the wheel. The battery pack may be a circular pack in which the battery cells may be evenly distributed. A battery pack diameter may be less than a wheel diameter, which may enable a user to easily insert the battery pack in the wheel. In some aspects, the battery pack may include a battery hub interface which may engage with a wheel hub interface associated with the wheel to secure the battery pack with the wheel. The battery hub interface may include a center portion, and a plurality of lug holes surrounding the center portion, similar to the wheel hub interface.

The battery pack may be removably connected to the wheel in different ways, which may enable the user to remove the battery pack from the spare wheel tire assembly, and further enable the user to remove the spare wheel tire assembly from a vehicle component without the battery pack. The vehicle component may be, for example, a vehicle bed, a vehicle carrier or a chase rack located at a vehicle back portion (e.g., a vehicle tailgate), a vehicle bottom portion (e.g., in proximity to a vehicle chassis), and/or the like. Such connection may enable the user to connect the spare wheel tire assembly to a vehicle hub (that connects the wheel to a vehicle axle), without the battery pack (i.e., like a conventional/standard spare wheel tire assembly without the battery pack). Alternatively, the spare wheel tire assembly with the battery pack may be connected to the vehicle hub as a single unit.

In some aspects, the vehicle component described above may include a retaining mechanism that may enable the user to retain the battery pack on the vehicle component when the user removes the spare wheel tire assembly from the vehicle component. For instance, the spare wheel tire assembly may be attached to the vehicle component by using a first set of bolts and the battery pack may be attached to the vehicle component by using a second set of holes. To remove the spare wheel tire assembly from the vehicle component without the battery pack, the user may disengage only the first set of bolts, and not the second set of bolts. In this manner, the user may remove the spare wheel tire assembly from the vehicle component without the battery pack, while still retaining the battery pack with the vehicle component.

In further aspects, the battery cells may be integrated to the tires, as described above. For example, the battery cells may be molded inside the tire. In this case, electrical conductors associated with the battery cells may also be molded in the tire. In further aspects, tire and electrical communicators may also be 3D printed around the battery cells. In additional aspects, the spare wheel tire assembly may include a protective element (e.g., a ring) that may surround the battery cells to protect the battery cells (e.g., when the spare wheel tire assembly is in use or connected to the vehicle hub). In further aspects, the tire may include a plurality of fluid or air passages that may cool the battery cells.

In some aspects, the battery pack (or the battery cells) may transfer power/energy to a vehicle main battery or any other vehicle component. In some aspects, the battery pack (or the battery cells) may provide the power to the vehicle main battery (or other vehicle components) via cables or connectors. In other aspects, the battery pack (or the battery cells) may provide power to the vehicle main battery (or other vehicle components) wirelessly.

The present disclosure discloses a system that may store the battery cells inside the spare wheel tire assembly (instead of separately storing the battery cells and the wheel tire assembly), which may save space in the vehicle. The battery cells may provide additional energy, and provide a portable power solution. The user may quickly and conveniently connect or disconnect the battery cells to/from the wheel, which may enable the user to remove the battery cells from the spare wheel tire assembly and use the spare wheel tire assembly as a conventional/standard wheel tire assembly without the battery cells. Further, the spare wheel tire assembly with the battery cells may act as a standalone power source that may supply power to other devices (e.g., other than the vehicle) or to other vehicles. In addition, the spare wheel tire assembly with the battery cells may be attached to the vehicle component (that may be located at the vehicle back portion or a vehicle rear end) to provide weight balancing for racing applications or off-road adventures. In some aspects, the vehicle may mount two spare wheel tire assemblies at a time to the vehicle component.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

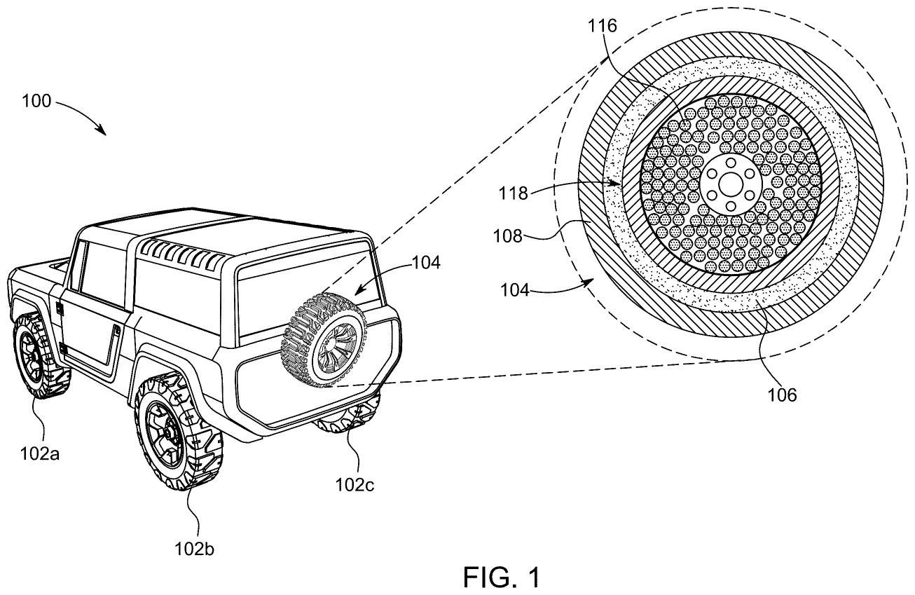

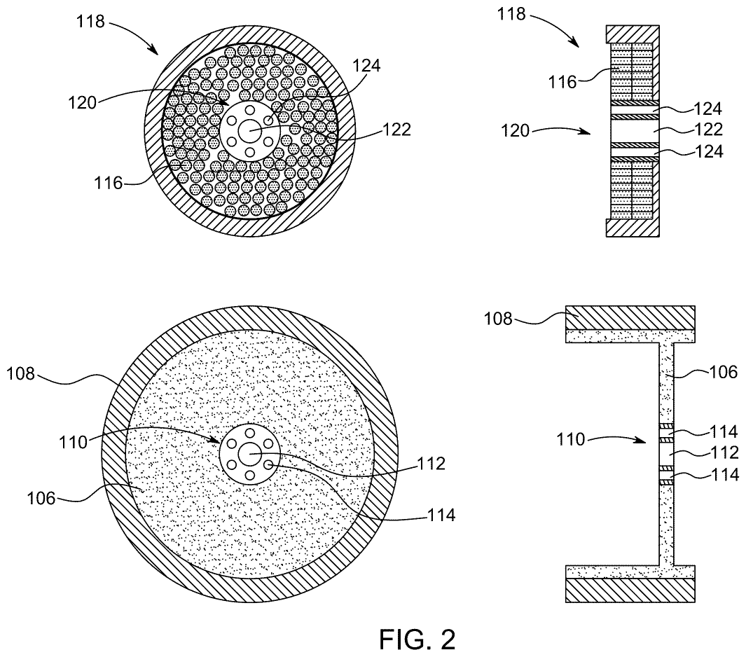

FIG. 1 depicts an example vehicle 100 in accordance with the present disclosure. While explaining FIG. 1, references will be made to FIGS. 2, 3, 4, 5, 6, and 7.

The vehicle 100 may take the form of any passenger or commercial vehicle such as, for example, a car, a work vehicle, a crossover vehicle, a van, a minivan, a taxi, a bus, etc. Further, the vehicle 100 may be a manually-driven vehicle, and/or be configured to operate in a fully autonomous (e.g., driverless) mode and/or partially autonomous mode. In some aspects, the vehicle 100 may be an Internal Combustion Engine vehicle, hybrid vehicle, or an Electric Vehicle (EV).

The vehicle 100 may include four main wheel tire assemblies 102a, 102b, 102c, etc. (hereinafter referred to as main wheel tire assembly 102), which may be connected to a respective vehicle axle. The vehicle 100 may further include a spare wheel tire assembly 104 (or spare wheel and tire assembly 104), which may be positioned anywhere on the vehicle 100, and may be connected to the vehicle axle if required (e.g., when any one main wheel tire assembly 102 may not work as per requirement). In some aspects, the spare wheel tire assembly 104 may be positioned/mounted on a vehicle component that may include, but is not limited to, a vehicle bed, a vehicle carrier or a chase rack located at a vehicle back portion (e.g., a vehicle tailgate), a vehicle bottom portion (e.g., in proximity to a vehicle chassis), and/or the like. The examples of the vehicle component described herein should not be construed as limiting.

Each of the main wheel tire assembly 102 and the spare wheel tire assembly 104 may include a wheel 106 and a tire 108. In some aspects, the wheel 106 may include a plurality of components including, but not limited to, a rim, spokes, a wheel hub interface 110, and/or the like. The wheel 106 may attach with a vehicle hub (not shown), via the wheel hub interface 110. In further aspects, the wheel 106 may attach with the vehicle component described above via the wheel hub interface 110. In an exemplary aspect, the wheel hub interface 110 may be a circular body located at a wheel center portion, which may include a first center portion 112 and first lug holes 114 (or a plurality of first lug holes) surrounding the first center portion 112, as shown in FIG. 2. The first center portion 112 may include a cap that may be positioned at a wheel front portion. As described above, the wheel hub interface 110 may engage with a vehicle hub (that connects the wheel 106 to the vehicle axle) to connect the wheel 106 to the vehicle axle, or to the vehicle component to connect the wheel 106 to the vehicle components (e.g., when the spare wheel tire assembly 104 is not in use). In some aspects, the vehicle hub and/or the vehicle component may include a plurality of posts, which may be positioned in a similar manner as the first lug holes 114 in the wheel hub interface 110. A vehicle owner (or user) may engage (e.g., insert) the posts with the first lug holes 114, and use lug nuts to secure the wheel 106 with the vehicle hub or the vehicle component.

The tire 108 may be a rubber or composite component that covers/surrounds the wheel 106, providing traction, cushioning, and grip on the road surface. In some aspects, the tire 108 may be a non-pneumatic tire. In alternative aspects, the tire 108 may be a pneumatic tire.

In some aspects, the spare wheel tire assembly 104 may include one or more battery cells 116 mounted inside the spare wheel tire assembly 104 (as shown in FIG. 1). The battery cells 116 may be Lithium-ion battery cells, which may store power/energy and provide power/energy to the vehicle 100 when the vehicle 100 requires additional power/energy. It should be understood that the battery cells may be other that Lithium-ion cells. In some aspects, the battery cells 116 may act as a backup power source that may provide additional power to a vehicle main battery when required (e.g., when the vehicle main battery may have a state of charge (SOC) less than a predefined threshold value). The vehicle main battery may be a traction battery (e.g., a Lithium-ion traction battery) that may provide power to electric motors of the vehicle 100. In some aspects, the vehicle main battery may provide power/energy to all the vehicle components to enable their operation, and the vehicle 100 may use the battery cells 116 only when additional energy is required or when the main battery's SOC is low.

In an exemplary aspect, the battery cells 116 may have a total capacity in a range of 4 KWh to 15KWh, which may provide incremental/additional range of 10-50 miles to the vehicle 100. In further aspects, the battery cells 116 may provide power to other vehicle components, (e.g., vehicle's HVAC unit, lighting system, etc., and may not only be used to increase the vehicle range). Since the battery cells 116 are mounted/packaged within the spare wheel tire assembly 104, the battery cells 116 may not take extra space for storage in the vehicle 100 (e.g., on the vehicle bed).

In some aspects, the battery cells 116 may be removably mounted in the spare wheel tire assembly 104. Specifically, in an exemplary aspect, the battery cells 116 may be removably connected to the wheel 106. It may be appreciated that removable connection between the battery cells 116 and the wheel 106 may enable the user to use either the battery cells 116 or the spare wheel tire assembly 104 based on the user or vehicle's specific requirement. In some aspects, the battery cells 116 may be assembled in a battery pack 118 (as shown in FIG. 2), which may be removably connected to the wheel 106. The battery pack 118 may be configured to be removed from the spare wheel tire assembly 104 (e.g., from the wheel 106), which may enable the user to conveniently remove the battery pack 118 from the spare wheel tire assembly 104 when required. As an example, the user may remove the battery pack 118 from the spare wheel tire assembly 104 when the user desires to connect the spare wheel tire assembly 104 in place of the main wheel tire assembly, or when the user desires to connect the spare wheel tire assembly 104 to the vehicle hub. In addition, the battery pack 118 may enable easy or convenient storage of the battery cells 116 inside the spare wheel tire assembly 104.

In additional aspects, the user may also use the spare wheel tire assembly 104 with the battery pack 118 (or without removing the battery pack 118 from the spare wheel tire assembly 104). In this case, the user may connect the spare wheel tire assembly 104 with the battery pack 118 as a single device/entity to the vehicle hub.

The battery pack 118 may be a circular pack/structure in which the battery cells 116 may be distributed evenly. The battery pack 118 may have dimensions corresponding to wheel dimensions. For instance, a battery pack diameter may be slightly less than or equivalent to a wheel diameter (e.g., a rim diameter), to enable the battery pack 118 to be tightly mounted within the wheel 106 (e.g., between the wheel hub interface 110 and the rim associated with the wheel 106). A wheel circumference (or the rim) may surround a battery pack circumference when the battery pack 118 is mounted within the wheel 106.

In some aspects, the battery pack 118 may include a battery pack hub interface 120 (hereinafter referred to as battery hub interface 120) that may be located at a battery pack center portion. The battery hub interface 120 may connect the battery pack 118 to the wheel 106 (e.g., to the wheel hub interface 110). Specifically, the user may connect the battery hub interface 120 to the wheel hub interface 110 to connect the battery pack 118 (including the battery cells 116) with the wheel 106. The battery hub interface 120 may be a circular body that may be located at the battery pack center portion. In some aspects, the battery hub interface 120 may include a second center portion 122 and second lug holes 124 that surrounds the second center portion 122. The battery hub interface 120 may further include one or more posts (not shown) that may enable the user to attach the battery pack 118 to the wheel 106. In some aspects, the battery cells 116 may be disposed between the battery hub interface 120 (specifically between an outer boundary/perimeter of the battery hub interface 120) and an outer boundary/perimeter of the battery pack 118.

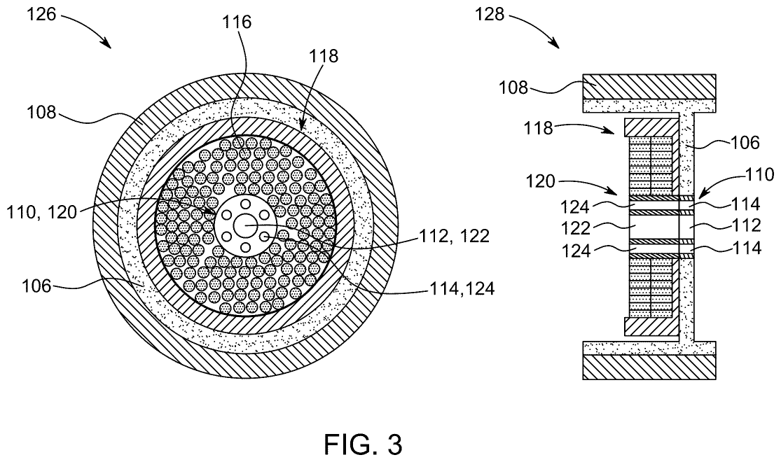

The battery hub interface 120 may be similar in configuration to the wheel hub interface 110. For instance, a battery hub interface diameter may be equivalent to a wheel hub interface diameter. Further, the second lug holes 124 may be arranged in a similar manner/pattern as the first lug holes 114 so that the second lug holes 124 may overlap or align with the first lug holes 114 when the user places the battery pack 118 on the wheel 106, to enable quick attachment of the battery pack 118 with the wheel 106. In some aspects, a count of the first lug holes 114 may be equivalent to a count of the second lug holes 124. Alternatively, the count of the first lug holes 114 may be different from the count of the second lug holes 124. Further, the second center portion 122 may overlap and align with the first center portion 112 when the user places the battery pack 118 on the wheel 106, to enable efficient attachment of the battery pack 118 with the wheel 106. A front view 126 and a cross-sectional view 128 of an assembled structure of the battery pack 118 and the wheel 106 (e.g., when the battery pack 118 is mounted inside the wheel 106 or the spare wheel tire assembly 104) is shown in FIG. 3.

The battery pack 118 may be removably connected to the wheel 106 in different ways, which may enable the user to remove the battery pack 118 from the spare wheel tire assembly 104, and further enable the user to remove the spare wheel tire assembly 104 from the vehicle component without the battery pack 118 (e.g., when the user desires to use the spare wheel tire assembly 104 without the battery pack 118). Such removable connection may enable the user to connect the spare wheel tire assembly 104 to the vehicle hub, without the battery pack 118 (i.e., like a normal spare wheel tire assembly without the battery pack 118). Exemplary ways in which the battery pack 118 may be removably connected to the wheel 106 are described below. The examples described below should not be construed as limiting, and the battery pack 118 may be removably connected to the wheel 106 in other ways as well, without departing from the scope of the present disclosure.

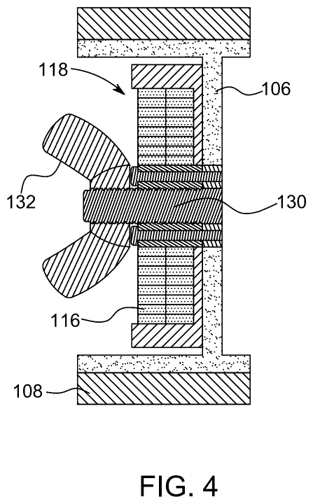

In a first example, the wheel 106 (e.g., the wheel hub interface 110) may include a spindle 130 that may be located at a wheel center portion, as shown in FIG. 4. In an exemplary aspect, the spindle 130 may be located at the wheel hub interface 110. The spindle 130 may be a threaded post or a threaded rigid cylindrical rod (having external threading) that may be mounted at the wheel center portion. In some aspects, the spindle 130 may be integrated to the wheel 106. In other aspects, the spindle 130 may be removably mounted on the wheel 106.

In some aspects, the battery hub interface 120 may engage with the spindle 130 to enable removable connection between the battery pack 118 and the wheel 106 (or to secure the battery pack 118 within the wheel 106). For instance, in this case, the second center portion 122 in the battery hub interface 120 may include a hole/aperture having a hole diameter equivalent to a spindle diameter. The second center portion 122 (or the hole) may receive the spindle 130, when the user inserts the battery pack 118 inside the wheel 106. When the user inserts the battery pack 118 inside the wheel 106, the user may use a fastener such as a nut 132 (e.g., a wing nut 132 having internal threading) or other securing/retaining apparatus to engage with the spindle 130, thereby locking/securing the battery pack 118 within the wheel 106, as shown in FIG. 4.

In an exemplary aspect, the wing nut 132 may be a butterfly nut with two large metal wings, one on each side, which enable the user to tighten or loosen the nut 132 by hand, without using any tools. By using the wing nut 132, the user may quickly and conveniently connect or disconnect the battery pack 118 with the wheel 106. In operation, the user may align the spindle 130 with the second center portion 122, and then insert the battery pack 118 in the wheel 106 such that the spindle 130 may cross/pass through the second center portion 122 (having the hole/aperture described above). When the user inserts the battery pack 118 into the wheel 106, the user may engage the nut 132 with the spindle 130 to lock the battery pack 118 inside the wheel 106.

In this case, the wheel 106 may include standard or conventional hub features (e.g., the first lug holes 114) that enable the wheel 106 to connect with the vehicle hub (e.g., when used as the main wheel tire assembly) or the vehicle component (e.g., when used as the spare wheel tire assembly and not connected to the vehicle hub/axle). The user may connect the battery pack 118 to the wheel 106 via a first attachment mechanism (e.g., by using the spindle 130 and the wing nut 132, as described above), and connect the wheel 106 to the vehicle hub/vehicle component via a second attachment mechanism (e.g., by using the first lug holes 114.). Use of separate connection mechanisms (e.g., the first attachment mechanism and the second attachment mechanism) may enable the user to remove the battery pack 118 from the spare wheel tire assembly 104 (e.g., by detaching the first attachment mechanism, without affecting the wheel's connection with the vehicle component), and further enable the user to remove the spare wheel tire assembly 104 from the vehicle component (e.g., by detaching the second attachment mechanism) without the battery pack 118.

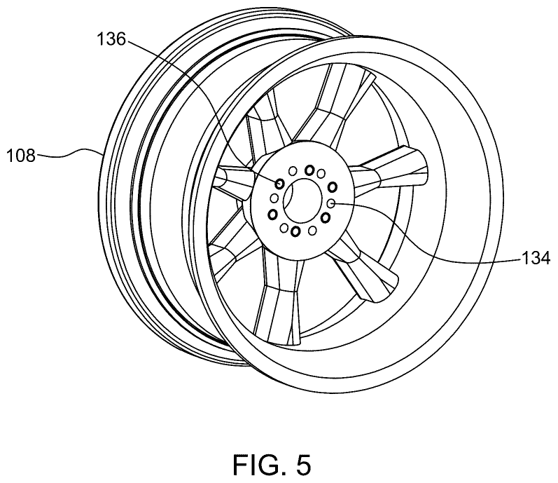

In a second example, the wheel 106 (e.g., the wheel hub interface 110) may include a first set of holes 134 and a second set of holes 136, which may collectively be part of the first lug holes 114, as shown in FIG. 5. The first set of holes 134 (or “primary holes”) may engage with the vehicle hub or the vehicle component, to enable connection between the wheel 106 with the respective vehicle hub. For example, the posts associated with the vehicle hub or the vehicle component may pass through the first set of holes 134, and a first set of lug nuts may then engage with the posts to secure the wheel 106 with the vehicle hub/vehicle component. The second set of holes 136 (or secondary holes) may engage with the battery pack 118, to enable connection between the wheel 106 and the battery pack 118. In some aspects, in this case, the battery hub interface 120 may include a plurality of posts (e.g., threaded posts, instead of the second lug holes 124) that may pass through the second set of holes 136, and a second set of lug nuts may then engage with the posts of the battery hub interface 120 to secure the battery pack 118 with the wheel 106. In this manner, the first and second sets of holes 134, 136 of the wheel 106 and the corresponding posts of the vehicle hub/vehicle component and the battery hub interface 120 may enable removable connection between the wheel 106 and the battery pack 118.

In some aspects, a first hole dimension (e.g., a first hole diameter) may be equivalent to a second hole dimension (e.g., a second hole diameter). Alternatively, the first hole dimension may be different from the second hole dimension. A count of the first set of holes 134 may be equivalent to or different from a count of the second set of holes 136. Further, the first set of holes 134 and the second set of holes 136 may be aligned and positioned in a circular array in the wheel hub interface 110, as shown in FIG. 5. The first set of holes 134 may be positioned in any manner relative to the second set of holes 136. For example, each hole associated with the second set of holes 136 may be positioned between two holes associated with the first set of holes 134.

In operation, the user may first align and insert the threaded posts associated with the vehicle hub/vehicle component with the first set of holes 134, and align and insert the threaded posts associated with the battery hub interface 120 with the second set of holes 136. Thereafter, the user may engage the first set of lug nuts and the second set of lug nuts with the respective posts, to secure the wheel 106 with the battery pack 118 and the vehicle hub/vehicle component separately.

In this manner, the user may connect the battery pack 118 with the wheel 106 via a first attachment mechanism (e.g., by using the second set of holes 136), and with the vehicle hub/vehicle component via a second attachment mechanism (e.g., by using the first set of holes 134). As described above, the use of separate connection mechanisms (e.g., the first attachment mechanism and the second attachment mechanism) may enable the user to remove the battery pack 118 from the spare wheel tire assembly 104, and further enable the user to remove the spare wheel tire assembly 104 from the vehicle component without the battery pack 118.

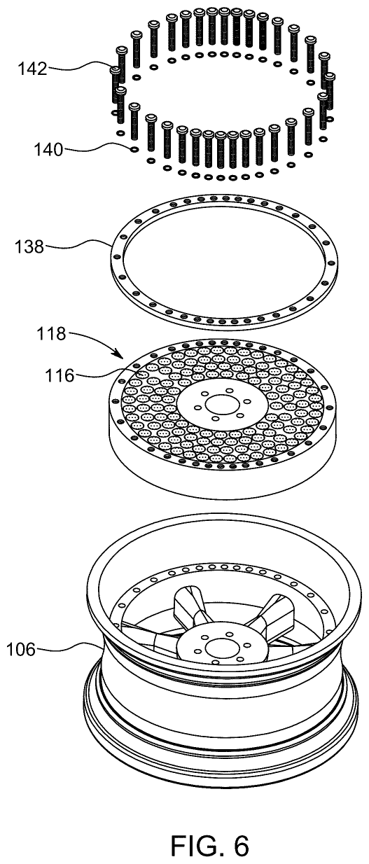

In a third example, the wheel 106 may include a bead lock ring 138 (shown in FIG. 6) that may engage with the battery pack 118, and connect the battery pack 118 to the wheel 106. It may be appreciated that the bead lock ring 138 is typically used to connect a tire bead (or a tire edge) associated with the tire 108 to the wheel 106 by using washers 140 and bolts 142, shown in FIG. 6. The bead lock ring 138 may be a circular ring that clamps down on the tire bead to prevent slipping of the tire 108 from the rim associated with the wheel 106. The bead lock ring 138 may include holes (e.g., threaded holes) that may receive the bolts 142.

The bead lock ring 138 may be removably attached to the rim associated with the wheel 106, which may lock/secure the tire bead to the wheel 106. The bead lock ring 138 may removably connect a back battery pack edge associated with the battery pack 118 to the rim. In operation, the user may position the battery pack 118 between the rim and the bead lock ring 138, and insert the battery pack 118 inside the rim. The user may then connect the back battery pack edge with the rim via the bead lock ring 138, the washers 140, and the bolts 142. The user may connect the wheel 106 to the vehicle hub or the vehicle component by using the standard hub features.

In this case, the user may connect the battery pack 118 to the wheel 106 via a first attachment mechanism (e.g., by using the bead lock ring 138), and to the vehicle hub/vehicle component via a second attachment mechanism (e.g., by using the first lug holes 114).

In further aspects, the user may connect the spare wheel tire assembly 104 and the battery pack 118 to the vehicle component separately (i.e., independently of each other). Similarly, the user may remove the spare wheel tire assembly 104 and the battery pack 118 from the vehicle component separately (i.e., independently of each other). In this manner, the user may remove the spare wheel tire assembly 104 from the vehicle component, and may use the spare wheel tire assembly 104 without the battery pack 118. In some aspects, the user may separately remove the spare wheel tire assembly 104 from the vehicle component, and main retain the battery pack 118 on the vehicle component. In such scenarios, the vehicle component may have a retaining mechanism that may enable the user to retain the battery pack 118 on the vehicle component when the user removes the spare wheel tire assembly 104 from the vehicle components without the battery pack 118.

As an example, in this case, the battery pack 118 may be bolted to a vehicle carrier (located on a vehicle back portion or tailgate) separately from the spare wheel tire assembly 104. For instance, the spare wheel tire assembly 104 may be bolted to the vehicle carrier by using primary bolts, and the battery pack 118 may be bolted to the vehicle carrier by using secondary bolts. As another example, the battery pack 118 may be bolted/connected to a vehicle chase rack (located on the vehicle bed or the vehicle back portion/tailgate) separately from the spare wheel tire assembly 104. As yet another example, the spare wheel tire assembly 104 may be connected to a vehicle bottom portion (e.g., under the vehicle, in proximity to a vehicle chassis) by using a primary hoist, and the battery pack 118 may be connected to the vehicle bottom portion by using a secondary hoist. Since the battery pack 118 and the spare wheel tire assembly 104 are connected by using separate mechanisms, the user may conveniently remove the spare wheel tire assembly 104 without the battery pack 118, and the battery pack 118 may still be connected with (or retained by) the corresponding vehicle component. The user may then use the spare wheel tire assembly 104 without the battery pack 118 (or connect the spare wheel tire assembly 104 to the vehicle hub without the battery pack 118).

In further aspects, the battery pack 118 may be a reconfigurable battery pack, which may enable the user to insert different counts of battery cells (e.g., a first count of battery cells or a second count of battery cells) inside the spare wheel tire assembly 104 as per user preference/requirement. For instance, the user may insert a large number of battery cells 116 inside the spare wheel tire assembly 104 when the user desires to travel to a far location and may require additional range.

In alternative aspects, the spare wheel tire assembly 104 and the battery pack 118 may be connected to the vehicle component together as a single entity, and the spare wheel tire assembly 104 and the battery pack 118 may be removed from the vehicle component together. Stated another way, in this case, the spare wheel tire assembly 104 and the battery pack 118 may be connected to the vehicle component by using a single connection mechanism. In this case, when the user detaches/removes the spare wheel tire assembly 104 from the vehicle component, the battery pack 118 may also be automatically removed from the vehicle component. Responsive to removing the “connected structure” of the spare wheel tire assembly 104 and the battery pack 118 from the vehicle component, the user may connect the “connected structure” to the vehicle hub, to use the spare wheel tire assembly 104 with the battery pack 118 as the main wheel tire assembly. In some aspects, in this case, the battery pack 118 may include a hub centric/lug nut interface (as the battery hub interface 120) and may utilize modified lug nuts to enable attachment of the battery pack 118 with the vehicle hub, which may be potentially supplemented by the wheel hub interface 110 for support.

In some aspects, instead of or in addition to attaching the “connected structure” to the vehicle hub as described above, the user may use the spare wheel tire assembly 104 with the battery pack 118 as a power source to supply power/energy to any other device (e.g., other than the vehicle 100) when the spare wheel tire assembly 104 with the battery pack 118 is removed from the vehicle 100. In such scenarios, the user may use the tire as an external tool to move (roll) the connected structure of the spare wheel tire assembly 104 with the battery pack 118 from a first location to a second location, at which the user may draw energy from the battery pack 118 to power the other device. In some aspects, the external tool may be a wheel barrow having a first tube (e.g., “L-shaped” tube) and a second tube (e.g., another “L-shaped” tube) that may engage with the spare wheel tire assembly 104 with the battery pack 118 (e.g., with the wheel hub interface 110 and the battery hub interface 120) to enable the user to conveniently move the spare wheel tire assembly 104 with the battery pack 118 from the first location to the second location (e.g., from a vehicle location to a camping location). In other aspects, the external tool may be another movement-enabling tool that may enable the user to conveniently move the connected structure from the first location to the second location, such methods include, but are not limited to, a dolly, traditional wheel-barrel, single or multi-person carry, or another vehicle.

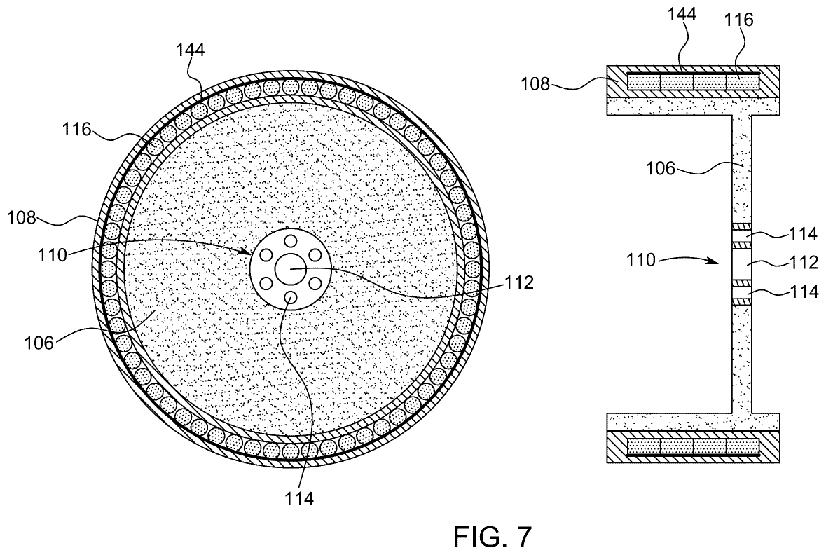

In further aspects, instead of being removably attached with the spare wheel tire assembly 104 (e.g., the wheel 106), the battery cells 116 (or the battery pack 118) may be integrated with the spare wheel tire assembly 104. In this case, in an exemplary aspect, the battery cells 116 may be integrated with the tire 108 (e.g., with a tire interior surface that faces the wheel 106), as shown in FIG. 7. In some aspects, the battery cells 116 may be molded inside the tire 108. In addition, electrical conductors associated with the battery cells 116 may also be molded in the tire 108. In further aspects, tire and electrical communicators may also be 3D printed around the battery cells 116.

In some aspects, the battery cells 116 may be located between the wheel 106 (e.g., the rim associated with the wheel 106) and the tire 108 when the battery cells 116 may be integrated with the tire 108, as shown in FIG. 7. The battery cells 116 may be disposed in a circular array along a tire perimeter. A count of the battery cells 116 may be based on a tire volume that may receive the battery cells 116. In some aspects, each battery cell may be disposed at a predetermined distance from adjacent battery cells, which may be less than a threshold value to accommodate a large count of battery cells in the spare wheel tire assembly 104. In further aspects, the battery cells 116 may be packaged in the spare wheel tire assembly 104 to protect the battery cells 116 (e.g., when the spare wheel tire assembly 104 is in use or connected to the vehicle hub).

In further aspects, the spare wheel tire assembly 104 may include a protective element that may surround the battery cells 116 to protect the battery cells 116 (e.g., when the spare wheel tire assembly 104 is in use or connected to the vehicle hub). In an exemplary aspect, the protective element may be a ring 144 that may surround the battery cells 116. In some aspects, the ring 144 may be molded or printed in the spare wheel tire assembly 104 to protect the battery cells 116. The ring 144 may be a circular ring having a diameter equivalent to or slightly less than a tire outer diameter, and may be disposed between the battery cell array and the tire interior surface, as shown in FIG. 7.

In further aspects, the tire 108 may include a plurality of fluid or air passages (not shown) that may cool the battery cells 116. In some aspects, the fluid/air passages may be molded on the tire 108 to promote fluid or air circulation to cool the battery cells 116. In this manner, the fluid or air passages may maintain the temperature of the battery cells 116. In some aspects, the fluid or air passages may be located on tire side edges. The fluid or air passages may be any size and/or shape, and may be disposed in any pattern on the tire 108.

In some aspects, the battery pack 118 (or the battery cells 116) may be configured to transfer (or exchange) power/energy to a vehicle main battery or any other vehicle or external component. In some aspects, the battery pack 118 (or the battery cells 116) may provide power to the vehicle main battery (or other vehicle components) via cables or connectors. In an exemplary aspect, the battery pack 118 (or the battery cells 116) may provide power to the vehicle main battery via the cables/connectors when the battery pack 118 (or the battery cells 116) may be connected to the vehicle component and not connected to the vehicle hub (via the spare wheel tire assembly 104). In some aspects, communication with the battery pack 118 relative to providing power instructions may be accomplished via Local Interconnect Network (LIN)/controller area network (CAN)/Ethernet, etc. In further aspects, for vehicles with two-way tire pressure monitoring system (TPMS) sensors (e.g., Bluetooth Low Energy based TPMS sensors), the TPMS sensor can also be used as a power control gateway interface when communicating with the tire 108 to deliver wireless power acceptance or delivery instructions. In further aspects, the battery pack 118 may charge the vehicle main battery by running DC to DC charger in reverse to prevent adverse situations.

In some aspects, to activate power transfer from the battery pack 118 (or the battery cells 116) to the vehicle main battery, the user may push a mechanical button or push button located on a vehicle charging port (not shown). This causes the battery pack 118 (or the battery cells 116) to boot. The vehicle 100 knows it is booting off the battery pack 118 (or the battery cells 116) by looking at main battery SOC level and the battery pack 118 (or the battery cells 116) SOC level. When the user pushes the mechanical button, the battery pack 118 (or the battery cells 116) turns on the high current output which is connected to an electrical system associated with the vehicle main battery, and the main DC to DC charger is set to run in reverse, and charges the vehicle main battery. When the vehicle 100 may be plugged to a charger, the vehicle 100 charges the battery pack 118 (or the battery cells 116) first (before the vehicle main battery) to ensure it is ready to work.

In an alternative aspect, the battery pack 118 (or the battery cells 116) may provide power to the vehicle main battery (or other vehicle components) wirelessly. For example, the battery cells 116 may wirelessly provide the power to the vehicle main battery when the spare wheel tire assembly 104 with the battery cells 116 may be attached to the vehicle hub, or when the spare wheel tire assembly 104 with the battery cells 116 may be in use and spinning (as the main wheel tire assembly).

In further aspects, the vehicle 100 may include a vehicle sensor (e.g., a tire pressure monitoring system (TPMS), not shown) that monitors air pressure inside the tire 108. The vehicle 100 may further include a vehicle processor that may receive inputs from the vehicle sensor, and may output a first notification, via a vehicle Human-Machine Interface (HMI), when the air pressure in the tire 108 is less than a threshold value. The first notification may indicate to the user that one main tire wheel assembly may have an air pressure less than the threshold value, and hence the user should replace it with the spare wheel tire assembly 104.

In some aspects, the vehicle processor may further cause the battery cells 116 to transfer power to the vehicle main battery (or other vehicle battery packs), responsive to outputting the first notification. The vehicle processor may cause the battery cells 116 to automatically transfer power to the vehicle main battery (or other vehicle battery packs) before the user removes/disconnects the spare wheel tire assembly 104 (with the battery cells 116) from the vehicle component and connects it to the vehicle hub. In some aspects, the vehicle processor may output a second notification on the vehicle HMI to indicate to the user that the vehicle processor may be initiating the power transfer, and hence the user should wait on removing the spare wheel tire assembly 104 till the power transfer is complete.

In further aspects, the spare wheel tire assembly 104 having the battery cells 116 may include inverters/plugs/connections to enable the spare wheel tire assembly 104 having the battery cells 116 to act as a standalone power source, which may supply power to other devices (e.g., other than the vehicle 100). In additional aspects, the spare wheel tire assembly 104 having the battery cells 116 may act as a power unit for wheel end motor technologies, in which power may be communicated via inductive or conductive means.

In further aspects, the vehicle component (e.g., a chase rack) may include electrical conductors, which may enable power exchange between the vehicle main battery and the battery cells 116. The electrical conductors may be integrated in the chase rack. The spare wheel tire assembly 104 having the battery cells 116 may electrically engage with the conductors in the chase rack to transfer power from the battery cells 116 to the vehicle main battery (or other vehicle components), when the spare wheel tire assembly 104 with the battery cells 116 is not in use. In further aspects, the spare wheel tire assembly 104 having the battery cells 116 (and other vehicle component such as chase racks) may include inductive or wireless chargers having wireless charging or energy transfer capabilities.

In additional aspects, the vehicle 100 may enable the user (or the vehicle processor) to select a direction of energy transfer from and to the battery cells 116 based on the requirement. For instance, the user (or the vehicle processor) may initiate power transfer from the vehicle main battery to the battery cells 116 when the vehicle 100 approaches a camping site (where the user may use the battery cells 116 or the battery pack 118 as a standalone power source). Alternatively, the battery cells 116 may provide power to the vehicle main battery when the main battery's SOC level is less than a threshold SOC value.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation. All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a wheel and tire assembly having a tire and a wheel; and
a battery cell mounted in the wheel and tire assembly, wherein the battery cell is configured to provide or store power.

2. The vehicle of claim 1, wherein the battery cell is removably mounted with the wheel.

3. The vehicle of claim 1, wherein the battery cell is part of a battery pack having a battery pack hub interface, and wherein the battery pack hub interface is configured to connect the battery pack to a wheel hub interface of the wheel.

4. The vehicle of claim 3, wherein the wheel hub interface comprises a spindle configured to engage with the battery pack hub interface, and wherein the spindle is configured to engage with a fastener to secure the battery pack within the wheel.

5. The vehicle of claim 3, wherein the wheel hub interface comprises a first set of holes configured to engage with a vehicle hub and a second set of holes configured to engage with the battery pack hub interface.

6. The vehicle of claim 3, wherein the wheel comprises a bead lock ring configured to engage with the battery pack, and connect the battery pack to the wheel.

7. The vehicle of claim 3, wherein the wheel and tire assembly and the battery pack are connected to a vehicle component separately, and the wheel and tire assembly and the battery pack are configured to be removed from the vehicle component separately.

8. The vehicle of claim 7, wherein the vehicle component comprises a retaining mechanism to retain the battery pack on the vehicle component when the wheel and tire assembly is removed from the vehicle component without the battery pack.

9. The vehicle of claim 7, wherein the wheel and tire assembly and the battery pack are connected to the vehicle component together as a single entity, and the wheel and tire assembly and the battery pack are configured to be removed from the vehicle component together.

10. The vehicle of claim 1, wherein the tire is a pneumatic tire.

11. The vehicle of claim 1, wherein the tire is a non-pneumatic tire.

12. The vehicle of claim 11, wherein the battery cell is integrated in the tire.

13. The vehicle of claim 12, wherein the battery cell is molded into the tire.

14. The vehicle of claim 12, wherein the battery cell is surrounded by a ring, and wherein the ring is disposed between the battery cell and the tire.

15. The vehicle of claim 12, wherein the tire comprises one or more fluid or air passages to maintain temperature of the battery cell.

16. The vehicle of claim 1, further comprising a main battery, wherein the battery cell is configured to transfer power to the main battery.

17. The vehicle of claim 16, wherein the battery cell is configured to transfer power to the main battery wirelessly.

18. The vehicle of claim 17, wherein the battery cell is configured to transfer power to the main battery via instructions obtained from a tire pressure monitoring system (TPMS) sensor.

19. A vehicle comprising:
a wheel and tire assembly having a tire and a wheel; and
a battery cell mounted in the wheel and tire assembly, wherein the battery cell is configured to provide or store power, and
wherein the battery cell is removably mounted with the wheel and tire assembly.

20. A wheel for a vehicle, comprising:
a battery cell removably mounted in the wheel, wherein the battery cell is configured to provide or store power, and
wherein the battery cell is part of a battery pack having a battery pack hub interface, and wherein the battery pack hub interface is configured to connect the battery pack to a wheel hub interface of the wheel.
